(19) United States
(12) Patent Application Publication
(10) Pub. No.: US 2006/0119467 A1
(43) Pub. Date: Jun. 8, 2006

(54) Method and device for localizing a transceiver device

(75) Inventors: Alain Marc Bernard Brillion, Villeneuve Tolosane (FR); Stefan Hammes, Regensburg (DE)

Correspondence Address: LERNER GREENBERG STEMER LLP, P O BOX 2480, HOLLYWOOD, FL, 33022-2480, US

(73) Assignees: SIEMENS AG; SIEMENS VDO AUTOMOTIVE S.A.S.

(21) Appl. No.: 11/297,574

(22) Filed: Dec. 8, 2005

(30) Foreign Application Priority Data
Dec. 8, 2004 (DE) 10 2004 059 179.2

(51) Int. Cl. G05B 19/00

(52) U.S. Cl. 340/5.1; 340/5.3

(57) ABSTRACT

A method and a device for executing a method for localization of at least one mobile transceiver embodied as an ID generator, especially as a vehicle key, in relation to a further transceiver device embodied as a base station. A request signal with at least one item of threshold information for the ID generator is transmitted by the base station. The request signal is received, if at all, by the ID generator. The field strength of the request signal is measured and compared to the at least one item of threshold information transmitted along with it and a corresponding response signal being output by the ID generator depending on the comparison.

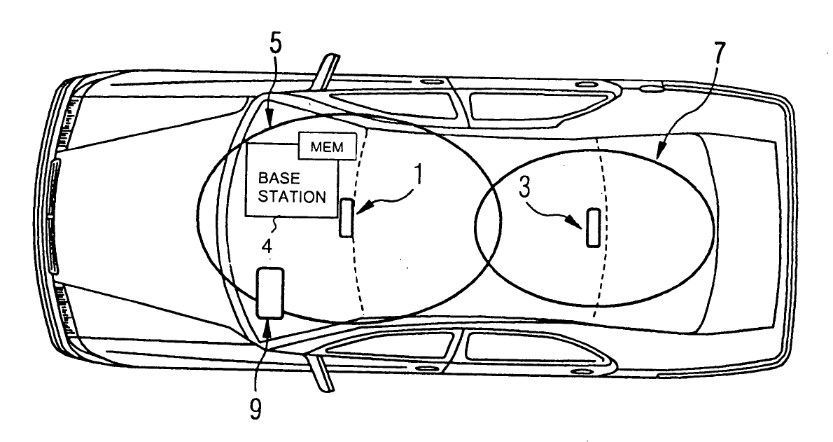

### BACKGROUND OF THE INVENTION

### FIELD OF THE INVENTION

The invention relates to a method for localization of a transceiver device, as is used for example in the motor vehicle technology for passive access control. The invention also pertains to a device and system for carrying out the method.

In such a passive access control system, for example, a user carries with them a transceiver device in the form of an ID generator as a key, a key fob, a smart card, a chip card, a watch, a remote control, or even an implant, on their body or close to their body.

This ID generator preferably executes, without the need to press any further keys, all the actions defined by approaching a motor vehicle, such as unlocking or locking the door locking system, enabling or disabling the immobilizer, starting the engine etc.

Since the actions depend on and differ according to the degree of proximity, especially “person is located inside the motor vehicle” or is “still outside the motor vehicle within a specific range”, it is desirable to localize the position of the ID generator and thus of the person in relation to the vehicle. To this end a transceiver arranged in the interior of the motor vehicle in the form of a base station is usually equipped with a number of inductive antennas, so that through its reception with a specific antenna (based on different ranges) the position of the ID generator can be determined from the base station.

In this case the base station or the control unit sends out requests in turn via the different inductive antennas which are usually accommodated at different locations, and detects, depending on the antenna from which the response signal of the ID generator was received, the position of the ID generator.

German published patent application DE 199 57 536 A1 proposes, to determine the position of the ID generator, that changes in distance be determined by continuous evaluation of a number of consecutive measurements. From the distance values and the associated distance changes the exact position of the ID generator can then be determined using a triangulation calculation. Disadvantageously determining the position of the ID generator for monitoring and distinguishing between the interior and the exterior is expensive.

German published patent application DE 102 21 427 A1 describes a method for localization of a transceiver device, wherein the transceiver device, especially a portable ID generator, is localized by an action “send response” of the ID-generator, which depends on the field strength of the send signal of the base station. In this case a desired receive sensitivity is set in the ID generator and a response is only sent to the base station on positive reception.

For reasons of convenience and safety it is necessary with these types of passive access systems, to obtain the most exact separation possible between vehicle interior space and vehicle exterior space. This is achieved for example by an ID (identification) generator receiving signals, which are emitted by LF antennas fitted inside or on the motor vehicle, with a desired receive sensitivity. Such a desired receive sensitivity could for example be found and set in the vehicle development in a so-called application phase on a prototype vehicle close to a series-production model. The receive sensitivity found in this case represents a compromise between as complete coverage as possible of the interior and the smallest possible external range of the internal antennas (overshoot). Disadvantageously however subsequent actual circumstances such as vehicle bodywork, antenna position etc. cause variations so that it is not possible overall, especially across a number of types of a model, to achieve an adequate or even a good compromise between maximum interior coverage and minimum overshoot.

### SUMMARY OF THE INVENTION

It is accordingly an object of the invention to provide a method and a device for the localization of a mobile transmitting station embodied as an ID generator, especially as a vehicle key, which overcomes the above-mentioned disadvantages of the heretofore-known devices and methods of this general type and which allows a unique localization of the ID generator in respect of a base station even with differing and/or changed circumstances.

With the foregoing and other objects in view there is provided, in accordance with the invention, a method for localizing at least one mobile transceiver embodied as an ID generator, such as a vehicle key, in relation to a further transceiver device embodied as a base station. The method comprises the following steps:
outputting, with the base station, a request signal with at least one predefined item of threshold information for the ID generator;
receiving the request signal with the ID generator, measuring a field strength of the request signal, and comparing with the at least one item of threshold information transmitted along with the request signal; and
outputting an appropriate response signal with the ID generator, in dependence on the comparison.

In other words, the field strength of a request signal sent out by the base station with predefined threshold information for the ID generator is measured and compared with the predefined threshold information transmitted with it. As an answer a response signal which depends on the result of the comparison is subsequently output by the ID generator. In this instance a response signal can preferably be output by the ID generator or only in the event of a positive comparison, for example measured field strength above the desired threshold value.

This guarantees a very variable system which on the ID generator side needs no modification to set other threshold values or threshold ranges (zones implemented by means of a number of different threshold values). Simply by changing the threshold value, which can preferably be read into the base station or into the memory device there and is thereby stored so that it can be modified, it is now possible to set another threshold value and thereby another effective range.

In a preferred embodiment of the invention a threshold value in the form of an individual parameter set per antenna is stored in the base station.

In a further embodiment of the invention a selection of predefined parameter sets per antenna is kept in reserve in the base station from which a specific parameter set can be selected as the active parameter set. This provides a cost effective and procedurally economic way of keeping stocks of a number of parameter sets, tested in a trial phase for example, for different changed circumstances. When the circumstances are produced and defined or also when these circumstances are changed at a later date it is then a simple matter to react in the optimum way by simply activating the corresponding parameter set.

As well as threshold values per antenna, additional further parameters such as transmit power, selection of antennas, etc. can be contained in a parameter set in order to arrange the transmit field characteristics in the desired form, so that these parameters too can be simply adapted (by reading them into the base station) to new of desired modifications.

In this case the parameter set or sets per antenna can also be newly described or read into the memory device of the base station through a specific mode, in order to also allow a later upgrade of the system to new optimized values determined later, as a result of field trials for example.

If a localization with a number of antennas is performed, it is conceivable to evaluate a number of responses together in the base station to allow for a more exact localization.

Other features which are considered as characteristic for the invention are set forth in the appended claims.

Although the invention is illustrated and described herein as embodied in a method and system for localizing a transceiver device, it is nevertheless not intended to be limited to the details shown, since various modifications and structural changes may be made-therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE is a schematic overhead view of a motor vehicle.

### DESCRIPTION OF THE EMBODIMENT

Referring now to the FIGURE of the drawing in detail, there is shown an exemplary implementation of the method in accordance with the invention. Here, the interior of a motor vehicle is monitored. To this end two LF or long-wave antennas 1 and 3 are located in the interior of the vehicle. The LF antenna 1 is positioned-in the forward area, for example centrally in the vehicle roof, in the mirror, or the like. The LF antenna 3 is disposed centrally in the rear of the vehicle, for example also on the vehicle roof, in the rear shelf, in the center console, the rear seat bench, or the like.

A base station 4 or control unit or controller, which is also disposed in the vehicle and is connected to the antennas 1 and 3, transmits via the antennas 1 and 3 for example, preferably starting with an action such as actuation of the door handle from outside by an operator.

Although transmit frequencies other than the long wave range, especially 125 kHz, can also be used, this band is particularly suitable for this application since there are likely to be few reflections in the long wave range and the interior of the vehicle because of the fact that usually the window openings are too small to enable long wave signals to escape.

If an ID generator 9 is now located in the range of a transmit field, as is shown in the single FIGURE for example, in the area of the transmit field of antenna 1, the ID generator preferably receives off-synchronized or triggered by an action, as explained above, a send telegram output via antenna 1. The send telegram, or query, also preferably contains an identification or code identifying the output location, i.e. the sending antenna, in order to enable different send antennas or their send telegrams to be distinguished in exemplary embodiments with a plurality of antennas. To avoid collisions the transmissions via different antennas are synchronized, meaning that they are undertaken in turn for example. If the ID generator 9, which, as shown in the example, is obviously located at the position of the driver or the driver's seat, now receives a request signal in the form of a send telegram from antenna 1 and subsequently a request signal in the form of a send telegram from antenna 3, then in accordance with the invention the information transmitted with the send telegram with the response threshold or threshold value to be set is read out in the ID generator. In addition the signal strength of the signal received at the position of the ID generator 9 is measured in the ID generator 9 and preferably buffered as a value.

Subsequently in the ID generator 9 the measured value of the signal field strength of the received request signal is compared with the (required) threshold value read out.

The result of the comparison, that is the measured signal field strength below or above the threshold value, is notified to the base station for example in its turn via the antennas 1 and 3 by the ID generator.

In the present example the threshold values for the signal field strength are depicted in the form of ellipses 5 or 7, so that in the case shown a positive response or “measured signal field strength above the threshold value of the antenna 1” is returned to antenna 1 and in the case of antenna 3 a negative result or “measured signal field strength below the threshold value valid for antenna 3” is returned.

This means that the result is available in the base station 4, or it can be easily analyzed, for example by means of a cross-reference table, that with these responses the ID generator must be located in the front of the vehicle. Where a more precise localization is not necessary, it is of course also conceivable to operate with just one antenna. On the other hand it is conceivable to also arrange a number of antennas, for example three, four or five, in the interior to allow more precise localization, for example front left, front right, rear left, rear right etc. in order to localize actions which correspondingly depend on this more precise position, such as control of the more exact interior lighting, control of the immobilizer, control of the engine start, control of individual settings such as seat positions, temperature etc.

As explained, an associated threshold value for each request signal or for each antenna is sent in each case, so that the threshold values are adapted to the corresponding circumstances and thereby the interior monitoring can be optimized. Such a threshold value is stored for this purpose in the base station in a memory device provided there, with not only the relevant threshold value for one antenna, but also if necessary the send power etc. being able to be stored in this memory as a set of parameters.

Such a parameter set is determined and optimized during manufacturing of a motor vehicle, preferably in what is referred to as an application phase using a model as close as possible to a series-production model, so that in the final production only the relevant parameter set has to be read into the memory of the base station.

To cover different model variants of a motor vehicle as economically as possible as regards methods and costs, as well as any changes envisaged in the circumstances, removal or installation or seats, sliding roof present yes/no, change of antenna position, addition or removal of antennas etc., a larger memory can be provided in the base station, in order to also store in advance parameter sets optimized and determined for these different circumstances. If a motor vehicle of a specific model type is now manufactured for specific circumstances, a selection can advantageously be made by activating or selecting a specific set of parameters for transmission of relevant antenna from a number of parameter sets in order to optimize the design of the function, localization or interior lighting function for the individual motor vehicle.

In addition this makes it possible, even if the circumstances change at a later date or if customers' requirements change, to simply activate another, possibly optimized parameter set for this motor vehicle, preferably as an operation to be performed in the workshop. Even an exchange of a parameter set, for example in the form of an upgrade, is easily possible in accordance with the invention, since this only requires a change to be made in the base station and all the ID generators or vehicle keys can remain unchanged.

The method in accordance with the invention and the device for executing such a method thus provides a low-cost and easy way of undertaking an exact localization, for example in the form of interior monitoring, with this desired localization being able to be adapted in a simple manner, for example to changes in the circumstances.

It is of course conceivable to apply the method in accordance with the invention to any localization of an ID generator, so that exterior monitoring can also implemented in this way. Naturally a number of different thresholds can be transmitted instead of one threshold, so that more detailed information can be provided even by means of one antenna, as to how far away the ID generator 9 is from the base station or wherein zone, for example between threshold 1 and 2 or between threshold 2 and 3 or 3 and 4 the ID generator is located, with these zones also being able to be stored by means of threshold values as predefined parameter sets in the base station.

This application claims the priority, under 35 U.S.C. § 119, of German patent application Nr. 10 2004 059 179.2, filed Dec. 8, 2004; the prior application is herewith incorporated by reference in its entirety.

We claim:

1. A method for localizing at least one mobile transceiver embodied as an ID generator in relation to a further transceiver device embodied as a base station, the method which comprises:
outputting, with the base station, a request signal with at least one predefined item of threshold information for the ID generator;
receiving the request signal with the ID generator, measuring a field strength of the request signal, and comparing with the at least one item of threshold information transmitted along with the request signal; and
outputting an appropriate response signal with the ID generator, in dependence on the comparison.

2. The method according to claim 1, wherein the mobile transceiver with the ID generator is a vehicle key.

3. The method according to claim 1, which comprises storing in the base station the at least one item of threshold information in the form of an individual parameter set for each transmit antenna of the further transceiver device.

4. The method according to claim 1, which comprises storing in the base station a selection of predefined parameter sets, and selecting therefrom a specific parameter set as an active parameter set.

5. The method according to claim 1, wherein a parameter set, in addition to threshold values for each antenna, also contains at least one further parameter selected from the group consisting of transmission power and a choice of transmit antennas, so as to arrange a send field characteristics in a desired form.

6. The method according to claim 1, which comprises entering the parameter set or a plurality of parameter sets into the base station.

7. The method according to claim 1, which comprises jointly evaluating a plurality of responses in the base station to improve a localization of the ID generator.

8. A device configured to execute the method according to claim 1, which comprises a system with a base station for transmitting a request signal with at least one predefined item of threshold information for the ID generator to be localized, wherein said base station includes a memory device for storing at least one predefined parameter set.

9. The device according to claim 8, wherein said memory device is configured for receiving and storing therein new parameter sets.

10. In combination, the device according to claim 8 and an ID generator configured for executing the method according to claim 1.

11. In a motor vehicle, a method for localizing an ID generator relative to the motor vehicle, which comprises:
outputting, with a base station mounted in the motor vehicle, a request signal containing at least one predefined item of threshold information for the ID generator;
upon receiving the request signal with the ID generator, measuring a field strength of the request signal, and comparing with the at least one item of threshold information transmitted along with the request signal; and
if appropriate in dependence on the comparing step, outputting a response signal with the ID generator and receiving the response signal with the base station for further processing.
